(19) United States
(12) Patent Application Publication
(10) Pub. No.: US 2005/0197425 A1
(43) Pub. Date: Sep. 8, 2005

(54) Thermosetting resin compositions, resin films and film articles

(75) Inventors: Tetsuaki Suzuki, Iruma-shi (JP); Naoya Kakiuchi, Iruma-shi (JP); Yasuhiro Noda, Iruma-shi (JP); Yusuke Tanahashi, Iruma-shi (JP)

Correspondence Address: OLIFF & BERRIDGE, PLC, P.O. BOX 19928, ALEXANDRIA, VA, 22320, US

(73) Assignee: TAMURA KAKEN CORPORATION, Iruma-shi (JP)

(21) Appl. No.: 11/067,952

(22) Filed: Mar. 1, 2005

(30) Foreign Application Priority Data
Mar. 2, 2004 (JP) 2004-57267
Jan. 13, 2005 (JP) 2005-6187

(51) Int. Cl. B32B 9/04

(52) U.S. Cl. 523/200

(57) ABSTRACT

An object of the present invention is to provide a thermosetting resin composition having a low dielectric constant, a low dielectric loss tangent, a low thermal expansion coefficient and an excellent peel strength at a low surface roughness after roughening adapted to additive process. The present invention provides a thermosetting resin composition comprising (a) 100 weight parts of polyfunctional vinyl benzyl ether compound, (b) 1 to 100 weight parts of solvent soluble polyimide resin, and (c) 0.01 to 10 weight parts of a catalyst for thermosetting reaction.

This application claims the benefits of Japanese Patent Applications P2004-57267, filed on Mar. 2, 2004, and P2005-6187, filed on Jan. 13, 2005, the entireties of which are incorporated by reference.

### BACKGROUND OF THE INVENTION

1. Technical field

The present invention relates to a thermosetting resin composition used for an adhesive, prepreg, casting, paint or the like and, in particular, used for producing a printed wiring board produced by semiadditive process or fully additive process. The present invention further provides a resin film produced by using the above resin composition, a resin film having a heat resistant film and resin produced by applying the above resin composition on the one or both side of the heat resistant film, and a metal foil having adhesive applied on the one side of the metal foil. The resin composition, resin film and metal foil may be used for a high density build-up printed wiring board having a low dielectric constant, low dielectric loss tangent, low thermal expansion coefficient, high adhesion strength, high thermal resistance and excellent reliability. The thus obtained printed wiring board may be used for a semiconductor plastic package or the like.

2. Related Art Statement

It has been recently demanded to lower the dielectric constant and dielectric loss tangent of a package substrate for MPU or ASIC for realizing high speed processing and responding to operation at a high frequency, as well as a reduction of line pitch, smaller diameter, narrower pad pitch and the increase of number of layers. It is required a high density build-up substrate or high density packaging substrate on the viewpoint of the substrate structure. It is also required to apply additive process instead of subtractive process for realizing a narrower line pitch, and to provide a smaller laser via for realizing a smaller diameter and narrower pad pitch. It is further required to lower the thermal expansion coefficient for improving the reliability and dimensional and positional precision. Further, for realizing operation at higher frequency, it is required to lower the dielectric constant and dielectric loss tangent for reducing the transmission loss and to lower the surface roughness for reducing the skin effect due to conductor processing profile.

It has been known, for example, film products described in the following documents proposed for solving the above problems.
Japanese patent publication 11-1547A
Japanese patent publication 11-87927A
Japanese patent publication 2000-17148A
Japanese patent publication 2000-198907A
Japanese patent publication 2003-238772A
Japanese patent publication 2001-181375A
Japanese patent publication 2002-241590A
Japanese patent publication 2002-309200A
Japanese patent publication 2003-127313A
Japanese patent publication 2003-321607A

### SUMMARY OF THE INVENTION

It has not been known, however, a material satisfying all the above listed requirements up to now. It is particularly true in a layer insulation material for use in a build-up substrate.

An object of the present invention is to provide a thermosetting resin composition having a low dielectric constant, a low dielectric loss tangent, a low thermal expansion coefficient and an excellent peel strength at a low surface roughness after roughening adapted to additive process.

Another object of the present invention is to provide a high density build-up printed wiring board produced by using the above thermosetting resin composition as the layer insulating material.

The thermosetting resin composition of the present invention comprises (a) 100 weight parts of polyfunctional vinyl benzyl ether compound, (b) 1 to 100 weight parts of solvent soluble polyimide resin, and (c) 0.01 to 10 weight parts of a catalyst for thermosetting reaction.

The present invention further provides a resin film in B-stage produced by the above composition. The present invention still further provides an article having a substrate comprising a heat resistant film or metal foil.

Although various methods have been proposed for realizing a low dielectric constant, low dielectric loss tangent and low thermal expansion coefficient, there is limits on these electrical properties due to the physical properties of epoxy base resin used for the resin film in B-stage. The inventors have intensively studied for providing a resin composition having a low dielectric constant, low dielectric loss tangent, and a low thermal expansion coefficient. They have tried to change the base resin to vinyl benzyl ether compound and a specific solvent soluble polyimide compound so as to remove hydroxyl groups of epoxy resin, a bottleneck for realizing low dielectric constant and dielectric loss tangent, as well as to improve the rigidity of the base resin. It have been successfully provided a novel resin composition having a low dielectric constant, a low dielectric loss tangent and low thermal expansion coefficient.

Although a cured product of a composition having only vinyl benzyl ether compound as the base resin has a low dielectric constant, a low dielectric loss tangent and low thermal expansion coefficient, it is extremely brittle so that it is considerably difficult to produce a resin film made of such cured product. The cured product is also inferior in the ease of roughening so that the adhesive strength is low. The present inventors have tried to add a specific solvent soluble polyimide resin to the resin composition as a denaturing material for imparting flexibility, and have found that the film properties can be successfully improved without deteriorating the dielectric properties. The present invention is based on the discovery.

It is further proved that the composition of the present invention can realize a large adhesive strength by forming roughened surface at a low profile. A further large adhesive strength can be easily realized by forming a roughened surface at a low profile by applying a filler material such as silica. It is also made possible to provide an interlayer insulating material having a low dielectric constant, a low dielectric loss tangent and an excellent peel strength at a low surface roughness after roughening, adapted to additive process. It is further found that it is possible to further reduce the thermal expansion coefficient by applying a liquid polymer film such as full aromatic aramide film or full aromatic polyester film as a central insulating layer.

These and other objects, features and advantages of the invention will be appreciated upon reading the following description of the invention when taken in conjunction with the attached drawings, with the understanding that some modifications, variations and changes of the same could be made by the skilled person in the art.

### PREFERRED EMBODIMENTS OF THE INVENTION

((a) Polyfunctional Vinyl Benzyl Ether Compound)

The polyfunctional vinyl benzyl ether compound (a) is a compound having an aromatic residual group (residual group of a polyvalent phenolic compound whose hydroxyl groups are excluded) and at least two vinyl benzyl ether groups bonded with the aromatic residual group.

The aromatic residual group bonded with the vinyl benzyl ether group may be a polyvalent phenolic group such as phenol novolak, cresol novolak, phenol aralkyl, naphthol aralkyl, biphenyl type phenol novolak, biphenyl type naphthol novolak and the like.

(a) The polyfunctional vinyl benzyl ether compound may preferably have the following general formula.

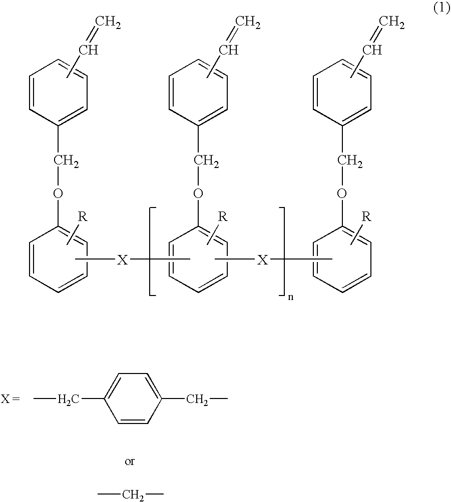

In the formula (1), “R” represents H or CH₃, and “n” represents an integer of zero or larger. When “n” represents zero, the compound has two vinyl benzyl ether groups. When the compound is used as a resin component of a thermosetting resin composition for coating, “n” may preferably be 2 or larger and more preferably be 5 or larger, on the viewpoints of ease of production of the resin composition, ease of coating and workability and handling on use. Further, although the upper limit of “n” is not particularly defined, “n” may be made 70 or lower, for example. When “n” is too large (for example, the molecular weight exceeds about 10000), anti-foaming property upon coating is deteriorated so that voids may be left in the resulting coating. On the viewpoint, “n” may preferably be 30 or lower and more preferably 25 or lower. Further, the molecular weight Mw may preferably be 1000 to 10000 and more preferably be 2000 to 8500.

The compound of the formula (1) may be easily obtained by dehydrochlorination using an inorganic alkali and dimethyl sulfoxide as a solvent from main raw materials of chloromethyl styrene monomer and polyfunctional phenolic compound.

((b) Solvent Soluble Polyimide Resin)

The solvent soluble polyimide resin (b) used in the present invention is soluble to a solvent such as NMP, DMF and DMAC and may preferably have a high Tg, a low dielectric constant and a low dielectric loss tangent. The polyimide resin may preferably be a soluble and fully imidized polyimide resin obtained by reacting diamino trimethyl phenyl indan and benzophenone tetracarboxylic dianhydride. In particular, the compound can improve the adhesion strength on the roughened surface without using another adhesion-giving agent.

The compound may preferably be those having the structural formula (repetition unit) of the following general formula (2).

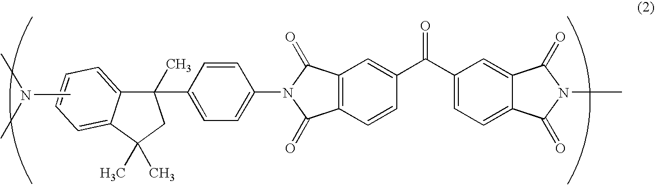

The used amount (solid content) of the solvent soluble polyimide resin (b) is made in a range of 1 to 100 weight parts with respect to 100 weight parts of the polyfunctional vinyl benzyl ether compound (solid content) (a). It is thus possible to improve the elongation, which is a characteristic property as a resin film, and tensile strength in a good balance. On the viewpoint, the used amount of the solvent soluble polyimide resin (b) may preferably be 50 weight parts or lower, and more preferably be 5 to 30 weight parts.

((c) Thermosetting Catalyst)

The thermosetting catalyst (c) used in the present invention is not particularly limited. The catalysts (c) include organic peroxides such as benzoyl peroxide, ketone peroxide, peroxyketal, hydroperoxide, dialkyl peroxide, diacyl peroxide, peroxy dicarbonate, peroxyester or the like; cationic series polymerization initiators; the other Redox series polymerization initiators; and the other radical polymerization initiators. Such catalyst (c) may be selected on the viewpoints of curing temperature, curing time, pot life or the like. The catalyst (c) may be used alone or in combination.

The used amount of (c) catalyst for thermosetting reaction is normally selected in a range of 0.01 to 10 weight parts with respect to 100 weight parts of (a) polyfunctional vinyl benzyl ether compound. When the used amount is lower than 0.01 weight parts, the hardening reaction by radical polymerization is not enhanced, so that the cured film may have insufficient heat resistance, resistance against solvents and insulating resistance. When the amount exceeds 10 weight parts, the cross linking density may be excessive to prevent sufficient surface roughening by permanganate solution or the like and thereby to reduce the adhesion of a copper plating film.

((d) High Molecular Weight Epoxy Resin or Phenoxy Resin)

(d) Component used in the present invention is a high molecular weight epoxy resin or phenoxy resin. It is possible to improve the flexibility of the resulting cured product by adding the high molecular weight epoxy or phenoxy resin (d). The addition of (d), however, tends to deteriorate the dielectric constant and dielectric loss tangent. The amount of (d) may be also decided on the economical point of view. The used amount of (d) may preferably be not higher than that of the solvent soluble polyimide resin and 50 weight parts or lower, and more preferably be 15 weight parts or lower, on the viewpoint of dielectric constant and dielectric loss tangent. When the amount of (d) exceeds that, the dielectric constant and dielectric loss tangent tend to be deteriorated.

Further, the high molecular weight epoxy or phenoxy resin (d) may preferably have a molecular weight (Mw) of 10000 or higher, and its resin structure may preferably be BPA, BPA/BPF, BPA/BPS, BP/BPS types or the like.

The component (e) is an inorganic or organic filler. Specifically, the filler (e) may preferably be fillers or compounds of low dielectric constants such as silica, PTFE (poly tetrafluoro ethylene), polystyrene, methyl silicone or polyphenylene ether. Further, the amount of the filler (e) may preferably be 0 to 100 weight parts.

Any kinds of fillers may be selected on the viewpoint of low dielectric constant and low dielectric loss tangent. Filler mainly composed of silica is preferred for lowering the thermal expansion coefficient. In this case, the filler mainly composed of silica may be subjected to a surface treatment with, for example, epoxy silane, amino silane, vinyl silane or the like. The particle diameter of the filler may preferably be 0.5 micrometer or lower on the viewpoint of responding to narrower pitch (L/S≦50/50 μm) and reducing the surface roughness (Ra≦0.5 μm) . 10 weight parts or more of the silica filler may preferably be added for improving the peel strength of the resulting film to a value of 0.5 kN/m or larger at a surface roughness of Ra<0.5 μm. Further, if the filler is added in an amount higher than 100 weight parts, the ease of processing with laser is deteriorated. The amount of the filler may preferably be 100 weight parts or lower.

A flame retarder may be added to the composition according to the present invention for imparting the flame retarding property. Flame retarders free of halogen include condensation type phosphoric esters, phosphazenes, polyphosphates, HCA (9,10-dihydro-9-oxa-10-phosphaphenanthrene-10-oxide) or the like.

Solvents usable in the resin composition according to the present invention is not particularly limited. The solvents may preferably a mixture of a solvent having a high boiling point such as NMP or diethylene glycol monomethyl ether acetate and a solvent having a low or medium boiling point such as cyclohexanone, MEK (methyl ethyl ketone) or toluene.

The thermal resin composition according to the present invention may be formed into a B-stage resin film. That is, the resin composition of the present invention is used to produce a thermosetting resin film in B-stage by means of a conventional process. For example, the resin composition is diluted with an appropriate organic solvents such as a mixed solvent of NMP (N-methyl-2-pyrrolidone)/toluene or the like to produce varnish. The varnish is then applied onto a polyethylene terephthalate film (PET film), optionally subjected to mold releasing process in advance, using a die coater and heated to obtain the film in B-stage.

The thermosetting resin film in B-stage is a semi-cured film at a stage between A-stage (non-cured) and C-stage (fully cured).

Alternatively, the thermosetting resin composition of the invention may be applied onto the either side or both sides of a surface treated film such as full aromatic amide film or full aromatic polyester film to produce a thermosetting resin film, on the substrate film base, having a still lower thermal expansion coefficient.

The full aromatic amide polymer includes polyparaphenylene terephthalic amide (PPTA). The full aromatic polyester polymer includes compounds having 2-hydroxy-6-naphthoic acid moiety or p-hydroxy benzoic acid moiety.

Alternatively, the thermosetting resin composition according to the present invention may be applied onto a metal foil to produce a metal foil coated with an adhesive. Such metal foil includes a copper foil and aluminum foil subjected to surface roughening and more preferably be copper foil.

The product with the film according to the present invention may be used for a printed wiring board having a non-through via hole such as a laser via as an HDI material of a build-up multi-layer board.

### EXAMPLES

The present invention will be described further in detail.

### Example 1

It was produced a mixture of 571 weight parts of vinyl benzyl ether resin “V-1000” (manufactured by SHOWA HIGHPOLYMER CO., LTD; molecular weight is 4000; resin solid content is 70 weight percent; component (a)), 300 weight parts of solvent soluble polyimide polymer “Q-VR-X0163” (PI RESEARCH & DEVELOPMENT COMPANY LIMITED; resin solid content is 20 weight percent; component (b)), 10 weight parts of condensation type phosphoric ester “PX-200” (manufactured by DAIHACHI CHEMICAL INDUSTRY CO., LTD.), 6 weight parts of “PERBUTYL Z” (manufactured by NOF Corporation; component (c)), and 100 weight parts of silica (average diameter of 0.3 μm; component (e)). To the mixture, a mixed solvent of NMPIMEK (7/3) was added to produce resin varnish having a solid content of 55 weight percent.

### Example 2

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 300 weight parts of solvent soluble polyimide resin “Q-VR-X0163” (PI RESEARCH & DEVELOPMENT COMPANY LIMITED; resin solid content is 20 weight percent; component (b)), 10 weight parts of condensation type phosphoric ester “PX-200” (manufactured by DAIHACHI CHEMICAL INDUSTRY CO., LTD.), 6 weight parts of “PERBUTYL Z” (manufactured by NOF Corporation; component (c)), and 100 weight parts of poly(tetrafluoroethylene) (PTFE) filler (Du Pont: component (e)). To the mixture, a mixed solvent of NMP/MEK (7/3) was added to produce resin varnish having a solid content of 55 weight percent.

### Example 3

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 300 weight parts of solvent soluble polyimide resin “Q-VR-X0163” (PI RESEARCH & DEVELOPMENT COMPANY LIMITED; resin solid content is 20 weight percent; component (b)), 10 weight parts of condensation type phosphoric ester “PX-200” (manufactured by DAIHACHI CHEMICAL INDUSTRY CO., LTD.), 6 weight parts of “PERBUTYL Z” (manufactured by NOF Corporation; component (c)), and 100 weight parts of PPO filler (Mitsubishi Gas Chemical Company, Inc.: component (e)). To the mixture, a mixed solvent of NMP/MEK (7/3) was added to produce resin varnish having a solid content of 55 weight percent.

### Example 4

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 200 weight parts of solvent soluble polyimide resin “Q-VR-X0163” (PI RESEARCH & DEVELOPMENT COMPANY LIMITED; resin solid content is 20 weight percent; component (b)), 100 weight parts of high molecular weight epoxy resin “YPS-007A30” (manufactured by Tohto Kasei Co. Ldt: Mw=about 40000; resin solid content is 30 weight percent; component (d)), 10 weight parts of condensation type phosphoric ester “PX-200” (manufactured by DAIHACHI CHEMICAL INDUSTRY CO., LTD.), 6 weight parts of “PERBUTYL Z” (manufactured by NOF Corporation; component (c)), and 100 weight parts of silica (mean particle diameter of 0.3 μm: component (e)). To the mixture, a mixed solvent of NMP/MEK (7/3) was added to produce resin varnish having a solid content of 50 weight percent.

### Example 5

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 250 weight parts of solvent soluble polyimide resin “Q-VR-X0163” (PI RESEARCH & DEVELOPMENT COMPANY LIMITED; resin solid content is 20 weight percent; component (b)), 10 weight parts of PPE filler “YPL-100LP” (manufactured by Mitsubishi Gas Chemical Company), 6 weight parts of “PERBUTYL Z” (manufactured by NOF Corporation; component (c)), and 100 weight parts of silica (mean particle diameter of 0.3 μm: component (e)). To the mixture, a mixed solvent of NMP/MEK (7/3) was added to produce resin varnish having a solid content of 55 weight percent.

### Example 6

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 300 weight parts of solvent soluble polyimide resin “Q-VR-X0163” (PI RESEARCH & DEVELOPMENT COMPANY LIMITED; resin solid content is 20 weight percent; component (b)), 6 weight parts of “PERBUTYL Z” (manufactured by NOF Corporation; component (c)), and 100 weight parts of silica treated with epoxysilane (mean particle diameter of 0.3 μm: component (e)). To the mixture, a mixed solvent of NMP/MEK (7/3) was added to produce resin varnish having a solid content of 55 weight percent.

### Example 7

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 300 weight parts of solvent soluble polyimide polymer “Q-VR-X0163” (PI RESEARCH & DEVELOPMENT COMPANY LIMITED; resin solid content is 20 weight percent; component (b)), 20 weight parts of high molecular weight epoxy resin “YPS-007A30” (manufactured by Tohto Kasei Co. Ldt: Mw=about 40000; resin solid content is 30 weight percent; component (d)), 6 weight parts of “PERBUTYL Z” (manufactured by NOF Corporation; component (c)), and 100 weight parts of silica treated with epoxysilane (ean particle diameter of 0.3 A m: component (e)). To the mixture, a mixed solvent of NMP/MEK (7/3) was added to produce resin varnish having a solid content of 55 weight percent.

### Example 8

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 300 weight parts of solvent soluble polyimide polymer “Q-VR-X0163” (PI RESEARCH & DEVELOPMENT COMPANY LIMITED; resin solid content is 20 weight percent; component (b)), 20 weight parts of polyamide resin containing hydroxyl groups “KAYAFLEX BP-30N” (manufactured by NIPPON KAYAKU CO., LTD.: Mw=about 50000, resin solid content is 30 weight percent), 6 weight parts of “PERBUTYL Z” (manufactured by NOF Corporation; component (c)), and 100 weight parts of silica treated with epoxysilane (mean particle diameter of 0.3 μL m: component (e)). To the mixture, a mixed solvent of NMP/MEK (7/3) was added to produce resin varnish having a solid content of 55 weight percent.

### Example 9

It was produced a mixture of 571 weight parts of vinyl benzyl ether resin “V-1000X” (manufactured by SHOWA HIGHPOLYMER CO., LTD; molecular weight is 4000; resin solid content is 70 weight percent; component (a)), 60 weight parts of solvent soluble polyimide resin “PI-100” (Maruzen Petrochemical Co., Ltd.), 6 weight parts of “PERBUTYL Z” (manufactured by NOF Corporation; component (c)), and 100 weight parts of silica treated with epoxysilane (mean particle diameter of 0.3 μm: component (e)). To the mixture, a mixed solvent of NMPIMEK (7/3) was added to produce resin varnish having a solid content of 55 weight percent.

### Comparative Example 1

It was produced a mixture of 651 weight parts of bisphenol-A type epoxy resin “EPICOAT 1001” (manufactured by JER Co. Ltd.: epoxy equivalent is 456: resin solid content is 70 weight percent), 300 weight parts of cresol novolak epoxy resin “YDCN-704P” (manufactured by Tohto Kasei co. Ltd.: epoxy equivalent of 210: resin solid content is 70 weight percent), 25 weight parts of dicyan diamide, 90 weight parts of condensation type phosphoric ester “PX-200” (manufactured by Daihachi chemical corporation), 230 weight parts of phenoxy resin “YP-55” (manufactured by Tohto Kasei co. Ltd.) and 0.7 weight parts of 2-ethyl-4-methyl-imidazole. Propylene glycol monomethyl ether (PGM) and dimethyl formamide were added to the mixture as mixed solvent to produce epoxy resin varnish having a solid content of 65 weight percent.

### Comparative Example 2

It was produced a mixture of 1000 weight parts of vinyl benzyl ether resin “V-1000X” (manufactured by SHOWA HIGHPOLYMER CO., LTD; molecular weight is 4000; resin solid content is 70 weight percent; component (a)), 14 weight parts of condensation type phosphoric ester “PX-200” (manufactured by Daihachi chemical corporation), 6 weight parts of “PERBUTYL Z” (manufactured by NOF Corporation; component (c)), and 100 weight parts of silica (component (e)). To the mixture, a mixed solvent of NMP/MEK (7/3) was added to produce resin varnish having a solid content of 60 weight percent.

Each of the above described resin varnishes was sufficiently dispersed with a three roll mill. The dispersed varnish was applied onto a polyethylene terephthalate film (PET film) having a thickness of 25 μm and with mold releasing treatment, by means of a die coater, and dried at 120° C. to produce a thermosetting resin film (A) in B-stage having a thickness of 50 μm. The volatile matter content of the film was adjusted at 1.5 weight percent. A polyethylene film (PE film) was laminated on the resin film as a protective film.

The thus obtained body was laminated on a copper foil having a thickness of 18 μm without surface treatment and charged in a vacuum press to heat the laminate at 170° C. for 60 minutes at a pressure of 4 MPa and a degree of vacuum of 5 Torr to obtain a shaped body (shaped body (1)).

Further, a circuit was formed on a FR-4 double faced copper clad laminate of a high Tg, a thickness of 0.2 mm and free of halogen (copper foil of 12 μm) (product name: “TLC-W-552Y” manufactured by KYOCERA Chemical Corporation). The conductor of the circuit was subjected to a treatment with black copper oxide. After the protective film was peeled off from the above B-stage resin film “A”, the resin films (A) were laminated on both sides of the copper-clad laminate. After the mold releasing film was peeled off, the resulting laminate was charged in a vacuum press and heated at 170° C. for 60 minutes at 4 MPa and a degree of vacuum of 1 Torr to perform the shaping. The shaped body was cooled and removed from the vacuum press, and blind via holes each having a predetermined diameter were formed with CO₂ laser.

The shaped body was treated with permanganate desmear solution for surface roughening and for removing and dissolving residual resin on the bottom of the via hole. 0.8 μm of electroless plating of copper and 20 μm of electroplating of copper were formed on the laminate, which was then subjected to after baking at 170° C. for 30 minutes. The above process was repeated to obtain a 6-layer build-up printed wiring board (I) having two build-up layers on both sides of the board, respectively.

Further, the above varnishes were applied on both sides of a substrate film of full aromatic polyamide having a thickness of 16 μm with a roll coater, and then dried at 120° C. to obtain a thermosetting resin film (B) in B-stage having a thickness of 30 μm on the substrate film of full aromatic polyamide resin. Using the film (B), a shaped body (2) on a copper foil without surface treatment and a six-layer build-up multilayered printed wiring board (II) having two build-up layers on both sides, according to the procedures described above for the film (A).

Tables. 1, 3 and 5 show the parameters of the above examples, respectively. Tables 2, 4 and 6 show the results of evaluation of properties in the above examples, respectively.

TABLE 1

| | | Example 1 | Example 2 | Example 3 | Example 4 | Example 5 |
|---|---|---|---|---|---|---|
| (a) | polyfunctional vinyl benzyl ether compound | 399.7 | 399.7 | 399.7 | 399.7 | 399.7 |
| | (solid content: weight) | | | | | |
| (b) | solvent soluble polyimide resin | 15 | 15 | 15 | 10 | 12.5 |
| | (weight parts with respect to | | | | | |
| | 100 weight parts of (a)) | | | | | |
| (c) | catalyst for thermosetting reaction | 1.5 | 1.5 | 1.5 | 1.5 | 1.5 |
| | (weight parts with respect to | | | | | |
| | 100 weight parts of (a)) | | | | | |
| (d) | high molecular weight epoxy resin or | 0 | 0 | 0 | 7.5 | 0 |
| | phenoxy resin | | | | | |
| | (weight parts with respect to | | | | | |
| | 100 weight parts of (a)) | | | | | |
| (e) | filler | 21.5 | 21.5 | 21.5 | 21.0 | 21.9 |
| | (weight parts with respect to | | | | | |
| | 100 weight parts of (a) + (b) + (c) + (d)) | | | | | |

TABLE 2

| Items | | | Example 1 | Example 2 | Example 3 | Example 4 | Example 5 |
|---|---|---|---|---|---|---|---|
| Dielectric constant (1 GHz) | Shaped body (1) Etching | | 2.6 | 2.5 | 2.5 | 2.8 | 2.6 |
| Dielectric loss tangent (1 GHz) | Shaped body (1) Etching | | 0.004 | 0.004 | 0.004 | 0.006 | 0.004 |
| Tg(° C.): TMA [symbol] | Shaped body (1) Etching | | 175 | 178 | 177 | 168 | 175 |
| C.T.E (ppm/° C.) | Shaped body (1) Etching | | 48 | 62 | 63 | 50 | 52 |
| | Shaped body (1) Etching | | 16 | 18 | 18 | 16 | 17 |
| Tensile strength (MPa) | Shaped body (1) Etching | | 80 | 85 | 83 | 80 | 85 |
| Elongation (%) | Shaped body (1) Etching | | 3.9 | 3.8 | 3.7 | 3.9 | 4.2 |
| Surface roughness Ra(μm) | PWB(I) | | 0.4 | 0.6 | 0.6 | 0.4 | 0.4 |
| Peel strength (kN/m) | | | 1.0 | 1.0 | 1.0 | 1.0 | 1.0 |
| Reliability | PWB(III) | (a) | >500 | >500 | >500 | >500 | >500 |
| (a: cycles) | | (b) | >1000 | >1000 | >1000 | >1000 | >1000 |
| (b: hrs) | PWB(IV) | (a) | >500 | >500 | >500 | >500 | >500 |
| | | (b) | >1000 | >1000 | >1000 | >1000 | >1000 |

TABLE 3

| | | Example 6 | Example 7 | Example 8 | Example 9 |
|---|---|---|---|---|---|
| (a) | polyfunctional vinyl benzyl ether compound | 399.7 | 399.7 | 399.7 | 399.7 |
| | (solid content: weight) | | | | |
| (b) | solvent soluble polyimide resin | 15 | 15 | 15 | 15 |
| | (weight parts with respect to | | | | |
| | 100 weight parts of (a)) | | | | |
| (c) | catalyst for thermosetting reaction | 1.5 | 1.5 | 1.5 | 1.5 |
| | (weight parts with respect to | | | | |
| | 100 weight parts of (a)) | | | | |
| (d) | high molecular weight epoxy resin or | 0 | 1.5 | 0 | 0 |
| | phenoxy resin | | | | |
| | (weight parts with respect to | | | | |
| | 100 weight parts of (a)) | | | | |
| (e) | filler | 21.5 | 21.2 | 21.5 | 21.5 |
| | (weight parts with respect to | | | | |
| | 100 weight parts of (a) + (b) + (c) + (d)) | | | | |

TABLE 4

| Items | | | Example 6 | Example 7 | Example 8 | Example 9 |
|---|---|---|---|---|---|---|
| Dielectric constant (1 GHz) | Shaped body (1) Etching | | 2.6 | 2.6 | 2.7 | 2.6 |
| Dielectric loss tangent | Shaped body (1) Etching | | 0.004 | 0.004 | 0.005 | 0.006 |
| (1 GHz) | | | | | | |
| Tg(° C.): TMA [symbol] | Shaped body (1) Etching | | 176 | 175 | 167 | 178 |
| C.T.E (ppm/° C.) | Shaped body (1) Etching | | 46 | 48 | 50 | 47 |
| | Shaped body (1) Etching | | 16 | 16 | 17 | 16 |
| Tensile strength (Mpa) | Shaped body (1) Etching | | 70 | 82 | 85 | 82 |
| Elongation (%) | Shaped body (1) Etching | | 3.0 | 3.9 | 4.2 | 4.2 |
| Surface roughness Ra | PWB(I) | | 0.4 | 0.4 | 0.4 | 0.4 |
| (μm) | | | | | | |
| Peel strength (kN/m) | | | 1.0 | 1.0 | 1.0 | 1.0 |
| Reliability | PWB(III) | (a) | >500 | >500 | >500 | >500 |
| (a: cycle) | | (b) | >1000 | >1000 | >1000 | >1000 |
| (b: hrs) | PWB(IV) | (a) | >500 | >500 | >500 | >500 |
| | | (b) | >1000 | >1000 | >1000 | >1000 |

TABLE 5

| | | Comparative | Comparative |
|---|---|---|---|
| | | Example 1 | Example 2 |
| (a) | polyfunctional vinyl benzyl ether | — | 700 |
| | compound | | |
| | (solid content: weight) | | |
| (b) | solvent soluble polyimide resin | — | 0 |
| | (weight parts with respect to | | |
| | 100 weight parts of (a)) | | |
| (c) | Thermosetting catalyst | — | 0.85 |
| | (weight parts with respect to | | |
| | 100 weight parts of (a)) | | |
| (d) | high molecular weight epoxy or | — | 0 |
| | phenoxy resin | | |
| | (weight parts with respect to | | |
| | 100 weight parts of (a)) | | |
| (e) | filler | — | 11.7 |
| | (weight parts with respect to | | |
| | 100 weight parts of | | |
| | (a) + (b) + (c) + (d)) | | |

TABLE 6

| | | | | Com- |
|---|---|---|---|---|
| | | | Comparative | paraTive |
| Items | | | Example 1 | Example 2 |
| Dielectric | Shaped body (1) | | 3.8 | 2.7 |
| constant (1 GHz) | Etching | | | |
| Dielectric loss | Shaped body (1) | | 0.02 | 0.005 |
| Tangent (1 GHz) | Etching | | | |
| Tg(° C.): TMA [symbol] | Shaped body (1) Etching | | 121 | 151 |
| C.T.E (ppm/° C.) | Shaped body (1) Etching | | 80 | 48 |
| | Shaped body (1) Etching | | 23 | 16 |
| Tensile strength | Shaped body (1) Etching | | 65 | 29 |
| (MPa) | | | | |
| Elongation | Shaped body (1) Etching | | 5.4 | 1.2 |
| (%) | | | | |
| Surface roughness | PWB(I) | | 0.9 | 1.5 |
| Ra (μm) | | | | |
| Peel strength | | | 1.0 | 0.3 |
| (kN/m) | | | | |
| Reliability | PWB(III) | (a) | 100 | 250 |
| (a: cycles) | | (b) | 150 | >1000 |
| (b: hrs) | PWB(IV) | (a) | 50 | 150 |
| | | (b) | 100 | >1000 |

Remarks: (PWB(III) PWB(IV)):

Test pattern substrates produced according to “JPCA-HD01” and obtained by procedures of producing PWB(I) and PWB(II) described above

(PWB (III) and PWB (IV))

PWB (III) and PWB (IV) shown in tables 2, 4 and 6 are test pattern substrates of JPCA-HD01 produced according to procedures of PWB (I) and PWB (II), respectively. (Dielectric constant: dielectric loss tangent)

Dielectric constant and dielectric loss tangent were measured with an impedance analyzer. (Reliability)

Reliability was evaluated by “JPCA-BU01”.

(a) Thermal shock test: A sample was held at 125° C. for 30 minutes and then at −65° C. for 30 minutes in a single cycle. The number of the cycles performed is shown in table 2.

(b) High temperature and high humidity bias test: 85° C., 85% RH DC=30V (measured in a bath)

As described above, according to examples 1 to 9 of the present invention, it is provided a resin composition for a high density build-up printed wiring board, having a low dielectric constant, low dielectric loss tangent, low thermal expansion coefficient, high adhesion strength and excellent heat resistance and reliability. A printed wiring board having such properties may be used for a plastic package of semiconductor.

The resin composition of comparative example 1 provides high dielectric constant, high dielectric loss tangent and high thermal expansion coefficient, a low Tg, and a low tensile strength, as well as inferior reliability of thermal shock test and high temperature and humidity bias test.

The resin composition of comparative example 2 contains (a) polyfunctional vinyl benzyl ether compound, (c) thermosetting catalyst and (e) filler. According to the comparative example 2, the dielectric constant, dielectric loss tangent and thermal expansion coefficient can be lowered. Tg was proved to be, however, low, the tensile strength and elongation were considerably reduced, the surface roughness was large and peel strength was low. Further, the reliability of thermal shock test and high temperature and humidity bias test was inferior.

The present invention has been explained referring to the preferred embodiments, however, the present invention is not limited to the illustrated embodiments which are given by way of examples only, and may be carried out in various modes without departing from the scope of the invention.

1. A thermosetting resin composition comprising:
(a) 100 weight parts of polyfunctional vinyl benzyl ether compound, (b) 1 to 100 weight parts of solvent soluble polyimide resin, and (c) 0.01 to 10 weight parts of a catalyst for thermosetting reaction.

2. The resin composition of claim 1, further comprising (d) a high molecular weight epoxy resin or high molecular weight phenoxy resin in a content not larger than that of (b) said solvent soluble polyimide resin and in a content of 50 weight parts or lower with respect to 100 weight parts of (a) said polyfunctional vinyl benzyl ether compound.

3. The resin composition of claim 1, further comprising (e) a filler in a content of 100 weight parts or lower, with respect to 100 weight parts of the total content of (a) said polyfunctional vinyl benzyl ether compound, (b) said solvent soluble polyimide resin, (c) said catalyst for thermosetting reaction and (d) said high molecular weight epoxy or high molecular weight phenoxy resin.

4. The composition of claim 1, wherein said (a) polyfunctional vinyl benzyl ether compound is represented by the following formula (1). 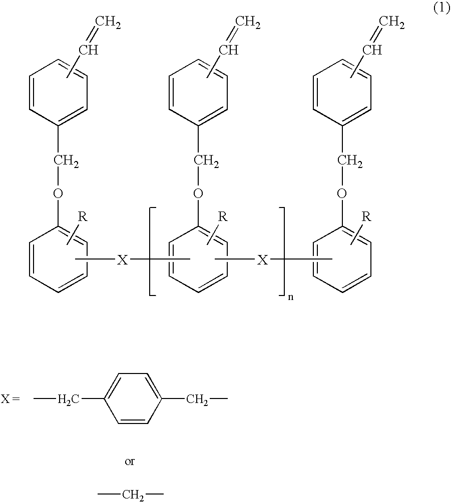
(In the formula, “R” represents H or CH₃, and “n” represents an integer of 0 or larger.)

5. The composition of claim 1, wherein (b) said solvent soluble polyimide resin comprises a fully imidized polyimide resin obtained by reacting diamino trimethylphenyl indan and benzophenone tetracarboxylic acid dianhydride.

6. The composition of claim 3, wherein (e) said filler comprises a material selected from the group consisting of silica, poly(tetrafluoroethylene), polystyrene, polyphenylene ether and methyl silicone and the mixtures thereof.

7. A resin film in B-stage produced from the composition of claim 1.

8. A film article comprising the resin film of claim 7 and a substrate comprising a heat resistance film or a metal foil.

9. The article of claim 8, wherein said heat resistant film comprises a full aromatic polyamide film or a full aromatic polyester film.
